(19) United States
(12) Patent Application Publication
(10) Pub. No.: US 2025/0319670 A1
(43) Pub. Date: Oct. 16, 2025

(54) DUAL EDGE BINDER MACHINE AND OPERATING METHOD

(71) Applicant: PACMAR TECHNOLOGIES LLC, Honolulu, HI (US)

(72) Inventors: Zachary P. Weindel, East Greenwich, RI (US); Milo Ferrazzoli, North Kingstown, RI (US)

(21) Appl. No.: 18/633,307

(22) Filed: Apr. 11, 2024

(51) Int. Cl. B29C 65/00; B29C 65/10; B29C 65/62; B29C 65/82; B29L 31/30

(52) U.S. Cl. CPC B29C 66/843; B29C 65/103; B29C 65/62; B29C 65/82; B29C 66/11; B29C 66/4326; B29C 66/729; B29C 66/73186; B29C 66/865; B29L 2031/30

(57) ABSTRACT

A dual edge binder machine and operating method. The dual edge binder machine includes a heat device configured to deliver heat adjacent to an interface between an upper roller and a lower roller. The dual edge binder machine further includes at least one motor rotationally coupled to the upper roller and the lower roller, respectively.

### TECHNICAL FIELD

The present description relates generally to a dual edge binder machine for welding a material assembly.

### BACKGROUND/SUMMARY

Drop stitch fabrics are used in a variety of fields such as recreational equipment industry and well as military and humanitarian applications, for example. Drop stitch fabrics include two woven fabric pieces with yarns that extends between the pieces of fabric. Drop stitch fabric is able to be coated with a polymer such as neoprene, thermoplastic polyurethane (TPU), polyvinyl chloride (PVC), etc. to create an airtight enclosure. The fabric structure can then be inflated and maintain a planar shape as opposed to cylindrical or spherical shapes which are typical in other types of inflatable structures. The planar shape is achieved through the use of the drop yarn in the fabric.

Thermoplastic coatings such as TPU and PVC can be heat welded to enclose and coat the drop stitch fabric. Current machines solely allow for bonding the enclosure material (commonly referred to as a sidewall) to a single drop stitch side at a time. In these machines, the material is then flipped over and the sidewall is bonded to the opposite drop stitch side. Using this material flipping technique can lead to undesirable twists in the fabric, other quality issues, and inhibits quick edge sealing of the fabric, in some cases.

US 2022/0219404 A1 to Jacobs discloses a material welder that is designed to weld two pieces of fabric together through the use of a heating device along with upper and lower bar assemblies which press the pieces of fabric together during the welding process. Jacobs' machine is supported via concrete pillars, thereby hindering the machine's transportability.

The inventors have recognized the several drawbacks with Jacobs' material welder and other previous heat welding devices. For instance, heat welding drop stitch fabric creates structural shapes (when inflated) that may not be desirable for many applications. For instance, as discussed above, other heat welding machines have exhibited undesirable fabric twisting and other material quality issues. Further, other welding machines have exhibited issues in relation to machine space efficiency and portability. To elaborate, Jacobs' material welder is stationary due to the use of concrete pillars at the base of the welder and poses difficulties with regard to feeding material into the machine for welding. Consequently, Jacobs' material welder may be constrained with regard to the size and the shape of products which are able to be welded, thereby decreasing customer appeal.

The inventors have recognized the abovementioned drawbacks and developed a dual edge binder machine to resolve at least some of the drawbacks. The dual edge binder machine, in one example, includes a heat device configured to deliver heated air to an upper nozzle and a lower nozzle. The machine additionally includes an upper roller and a lower roller. The dual edge binder machine further includes a first motor and a second motor rotationally coupled to the upper roller and the lower roller, respectively. In the machine, the upper nozzle and the lower nozzle are positioned adjacent to an interface that is formed between the upper roller and the lower roller and are configured to deliver heated air to an upper side and a lower side of a material assembly (e.g., a fabric assembly, a polymer assembly, and the like). The machine further includes a sidewall spool with a roll of sidewall material. Further, in the machine, the heat device, the upper roller, and the lower roller are configured to weld an upper piece and a lower piece to a sidewall in the material assembly. In this way, the dual edge binder machine is able to efficiently simultaneously weld two sides of the material assembly via a space efficient machine which allows the material assembly to be more easily fed into the roller interface where the heat welding takes place and reduces the chance of fabric twisting.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1-4 show different views of an example of a dual edge binder machine.

FIG. 5 shows an example of a drop stitch fabric assembly.

FIG. 6 shows a cross-sectional view of a drop stitch fabric assembly.

FIG. 7 shows a top plate and a bottom plate for the dual edge binder machine.

FIG. 8 shows a detailed view of a folder in the dual edge binder machine.

FIGS. 9-13 show another example of a folder for the dual edge binder machine.

FIG. 14 shows a sidewall fabric fed into the folder.

FIG. 15 shows the folder in use in the dual edge binder machine.

FIG. 16 shows a detailed view of an upper nozzle, a lower nozzle, and a heat shield in the dual edge binder machine.

FIGS. 17-18 show detailed views of a swivel for the heating assembly in the dual edge binder machine.

### DETAILED DESCRIPTION

A dual edge binder machine is described herein which is capable of simultaneously welding sidewall material to upper and lower layers of a material assembly. Simultaneously welding the upper and lower layers reduces the chance of (e.g., eliminates) misalignment, which results in undesirable twisting or warping of the final product. The user of the machine is able to either feed the material through the machine or place the material on a table and use the mobility of the machine to heat weld along the stationary material. In this way, the machine achieves increased adaptability and applicability.

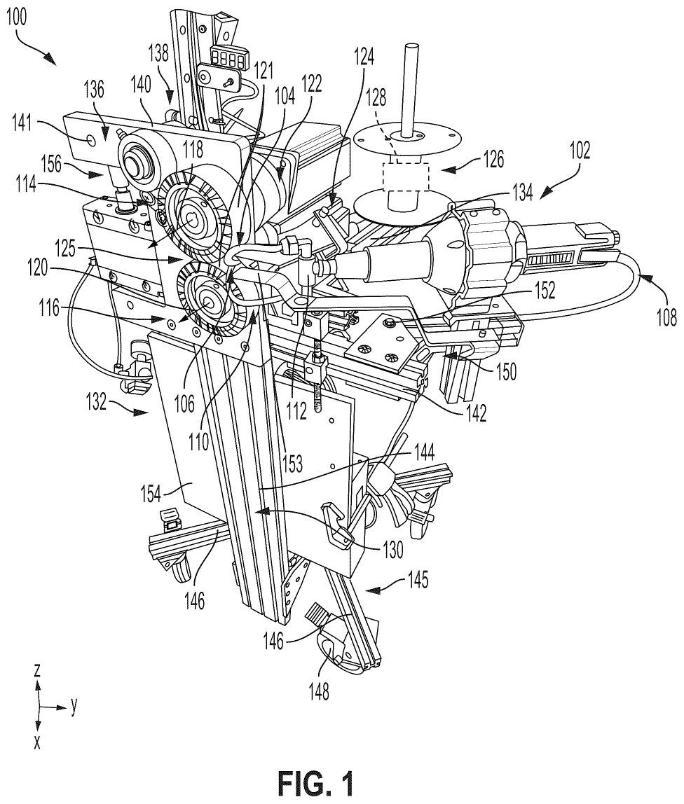

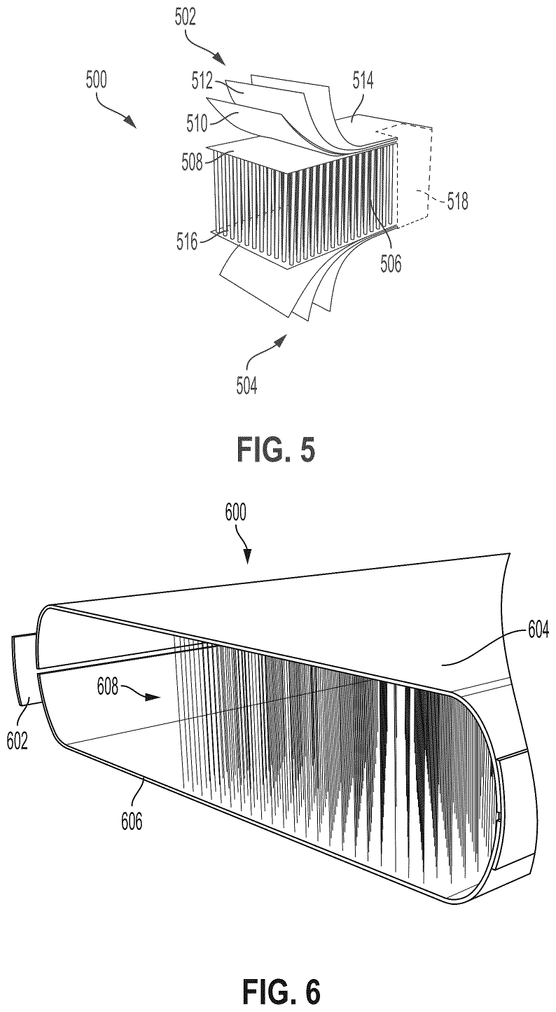

FIG. 1 shows a dual edge binder machine 100 that is configured to simultaneously weld two sides of a material assembly such as a drop stitch fabric assembly or other suitable materials such as plastics. An example of a drop stitch fabric assembly is depicted in FIG. 5. As illustrated in FIG. 1, the dual edge binder machine includes a heat device 102. The heat device 102 may be configured to simultaneously deliver heated air to an upper nozzle 104 and a lower nozzle 106, in the illustrated example. To achieve this functionality, the heat device 102 may include a heating element (e.g., an electric heating element), a fan, an electrical power interface 108, and the like. Air piping 110 may be used to deliver the heated air to the nozzles 104, 106. To elaborate, the air piping may include a dual outlet joint 112 which splits the flow of the heated air for material welding operation. In this way, heated air is efficiently delivered to the welding nozzles to heat both the outer polymer layer of the upper and lower materials and the inner polymer layer of the sidewall. In some examples, the lengths of the air piping 110 and nozzles 104, 106 may be configured to provide equal lengths for the flow path of the air to maintain consistent air temperatures and flow at each of the nozzles 104, 106. However, other heat device configurations may be used, in alternate examples. In some examples, the dual outlet joint 112 may smoothly divide and direct the air in a way that results in smother flow of the hot air, resulting in increased thermal efficiency and reduced heat losses. In other examples, the dual outlet joint 112, air piping 110, and/or nozzles 104, 106 may be thermally insulated or coated to reduce heat losses. In the illustrated example, a single heat device 102 is used. In other examples, multiple heat devices may be used, which however increases cost, power consumption, and the like. In other examples, alternative heat sources for the heat device 102 are possible, such as hot wedges, radiation devices, radio frequency devices, ultrasonic devices, and the like that are configured to simultaneously weld two sides of a material assembly (e.g., a drop stitch fabric assembly).

The dual edge binder machine 100 further includes an upper roller 114 and a lower roller 116. The upper roller 114 rotates about axis 118 and the lower roller 116 rotates about axis 120. The upper and lower rollers may include polymeric outer sections 121 that contact the material during heat welding, but other roller materials may be used based on the coating types, thicknesses, and applications. In some examples, the rollers may be interchangeable. For example, a knurled metallic roller may be used to create patterns in the welded material to increase grip/traction, whereas a high-durometer silicone wheel may be used for standard applications. In some examples, polytetrafluoroethylene (PTFE) tape may also be used on the rollers to extend the life of the wheels. FIG. 5 shows an example of a drop stitch fabric assembly that may be produced via the dual edge binder machine shown in FIGS. 1-4 and is discussed in greater detail herein.

As illustrated in FIG. 1, the rollers 114, 116 are driven via a motor 122 (e.g., an upper motor) and a motor 124 (e.g., a lower motor). To elaborate, the rollers 114, 116 and the motors 122, 124 may be coaxially arranged to increase machine compactness and reduce machine complexity. However, in other examples, gears, shafts, belts, combinations thereof, and the like may be used to transfer mechanical power from the motors to the rollers. In yet other examples, a single motor may be used, and gears, shafts, belts, combinations thereof, and the like may be used to transfer mechanical power from the single motor to both rollers.

The motors 122, 124 may be stepper motors, in one example. The stepper motors are a type of brushless DC motors that have a low complexity construction and are able to achieve a relatively high torque at start up. However, the motors may have other constructions in alternate examples. Further, the motors 122, 124 are electronically coupled to drivers which receive electrical energy from power supplies. The drivers may be incorporated into the control assembly, which is discussed in greater detail herein. However, other driver locations are possible.

The upper nozzle 104 and the lower nozzle 106 are arranged next to an interface 125 which is formed between the rollers 114, 116. The dual edge binder machine 100 further includes a sidewall spool 126. The sidewall spool 126 may have a roll of sidewall material 128 arranged thereon, which is schematically depicted in the illustrated embodiment. The sidewall spool 126 may be coupled to a vertical beam 130 in a support frame 132 via a spool beam 134, for instance. The support frame is discussed in greater detail herein.

In the illustrated example, the upper roller 114 and the lower roller 116 are positioned on a first side 136 of the dual edge binder machine 100 and the motors 122, 124 are positioned on a second side 138 of the machine which is opposite to the first side. Designing the machine with this type of construction allows the material to be more easily fed into the interface 125 between the rollers 114, 116.

An upper drive plate 140 (e.g., jaw) may be included in the dual edge binder machine 100. The upper drive plate may pivot on a hinge 141. In the illustrated example, the actuator 156 pushes up, which rotates the upper drive plate and causes the upper roller 114 to lower. In some examples, there is a top plate and a bottom plate in the machine, where the upper roller is mounted to the top plate, the bottom roller is mounted to the bottom plate, and the top plate is pivotally mounted to the bottom plate via a hinge to allow opening and closing of the gap between the rollers. In an alternate example, the dual edge binder machine may include vertically actuated rollers. The machine may include both an adjustable mechanical limit (with regard to drive plate travel) and adjustable pressure functionality through the use of an actuator.

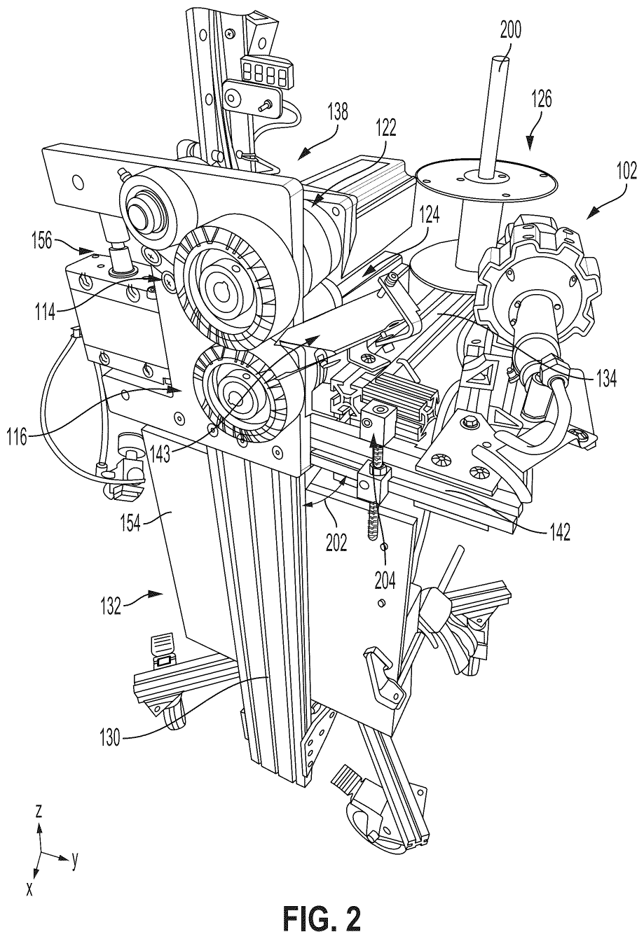

The dual edge binder machine 100 may further include a sidewall folder 143, shown in FIG. 2, that folds the sidewall in preparation for binding. The sidewall folder may also function as a constraint for the material position in the binding machine. The folding produces some feed tension for the sidewall, and there are some additional retaining features that also produce tensions. These are all adjustable and can be repositioned as desired. In other examples, the dual edge binder machine may include a tensioning device that is configured to tension the sidewall and is separate from the sidewall folder.

As illustrated in FIG. 1, the upper drive plate 140 may be coupled to the support frame 132. Further, the support frame 132 includes the vertical beam 130 and a cross-beam 142, in the illustrated example. Further, the upper drive plate 140 is mounted to the cross-beam 142, in the illustrated example. However, other suitable support frame structures may be used in other examples. The vertical beam 130 and the cross-beam 142 may be constructed out of extruded metal with channels 144 that enable other components to be efficiently mounted thereto. However, other suitable construction materials may be used in other examples. In some examples, the support frame 132 may allow for height adjustment to account for various table heights, users, etc.

The support frame 132 may further include base 145 with base beams 146. However, other suitable base configurations may be used in other examples. Wheels 148 (e.g., casters) may be coupled to ends of the base beams 146 to allow the machine to be efficiently moved around the workspace. The wheels 148 may also include locking features to enable use of the dual edge binder machine 100 in a stationary configuration.

The heat device 102 may be mounted to the cross-beam 142 via a heat device mounting structure 150 which may include a pivot 152. In this way, the heat device 102 is able to be engaged and disengaged from the material (e.g., drop stitch fabric) to initiate or stop the welding process. In some examples, the heat device mounting structure may contain features that allow for limit adjustments, locking mechanisms, and actuators to provide more consistent engagement of the heat device 102 with the material. In some examples, there may be a heat shield 153 (between the nozzles) to help keep the material from contacting the lower nozzle 106 and getting melted or damaged.

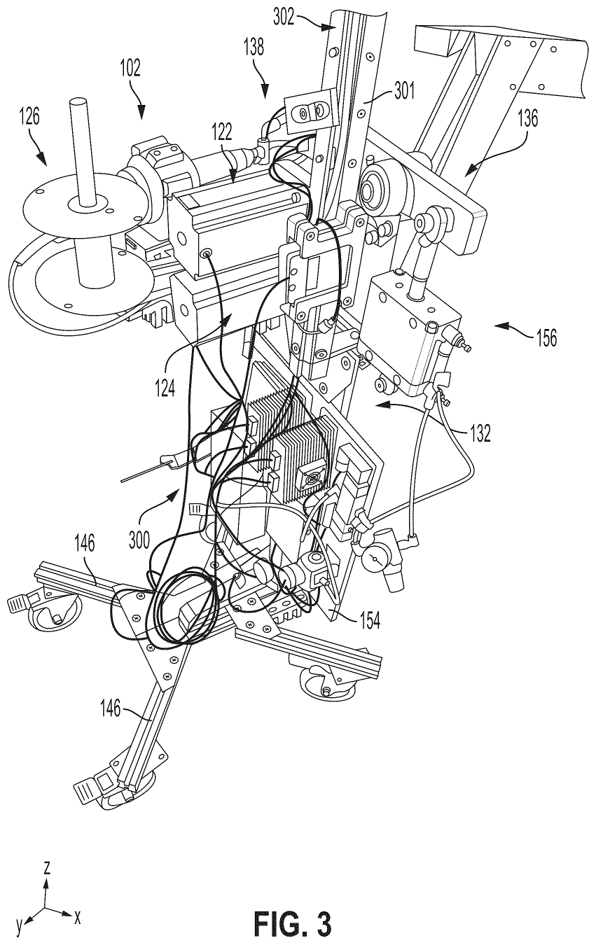

The support frame 132 includes an electronics mounting structure 154 which is coupled to the vertical beam 130, in the illustrated example. The electronics mounting structure 154 is described in greater detail herein with regard to FIG. 3.

It will be appreciated that material which is slated for welding may either be fed through the dual edge binder machine 100 or placed on a table. When the material is placed on the table, the mobility of the machine is able to be used to heat weld along the stationary material which is placed on the table. The mobility of the dual edge binder machine 100 depicted in FIG. 1 creates flexibility when heat welding comparatively large size drop stitch structures, in one example.

In the example illustrated in FIG. 1, an actuator 156 is included in the dual edge binder machine. When the actuator 156 extends, the upper drive plate 140 rotates about upper drive plate hinge 141, which causes the upper roller 114 to lower to engage with the material. In some examples, there may be a mechanical adjustment to limit the drive plate travel. In some examples, the actuator may be a pneumatic actuator, and the pressure can be adjustable. However, the actuator may also be a manual device, a spring loaded device, an electric device, a hydraulic device, or any other suitable mechanism. The heat shield 153 and the sidewall folder 143 may include an anti-friction coating such as PTFE, a ceramic coating, combinations thereof, and the like to decrease surface friction to enable the material assembly to be more effectively heat welded.

FIG. 2 shows another view of the dual edge binder machine 100. As shown, the position of the heat device 102 has been shifted in relation the device's position depicted in FIG. 1. In this way, the heat device 102 can be engaged and disengaged from the material to initiate or stop the welding process. The heat device 102, the rollers 114, 116, the motors 122, 124, the frame 132, the actuator 156, and the sidewall spool 126 are again shown in FIG. 2. The spool 126 may rotate about a shaft 200. The shaft 200 is vertically aligned in the illustrated example. However, alternate spool shaft orientations are possible. The electronics mounting structure 154 is again shown in FIG. 2. The electronics mounting structure 154 is positioned on the side 138 of the machine to reduce the chance of the electronics interfering with material manipulation during the welding process. Further, the electronics mounting structure 154 may be positioned directly below the cross-beam 142 to lower the machine's center of gravity, thereby allowing the machine to be more easily moved around the manufacturing facility. However, alternate mounting structure locations have been contemplated.

The vertical beam 130 and the cross-beam 142 intersect at an angle 202. The angle 202 may be 90°, in one specific use-case example. Further, the cross-beam 142 may be laterally aligned to allow the material to be efficiently fed into the machine. However, other support structure architectures may be used, in other examples. The spool beam 134 may be coupled to the cross-beam 142 via a stabilizer 204 that reinforces the cantilevered beam/arm structure. However, in other examples the stabilizer may be omitted from the machine. Alternatively, in another example, the cross-beam may be fixedly coupled to the spool beam.

FIG. 3 shows another view of the dual edge binder machine 100. Again, the heat device 102, the motors 122, 124, the support frame 132, the actuator 156, and the sidewall spool 126 are illustrated.

The dual edge binder machine 100 may further include a control assembly 300 with a controller (e.g., a microcontroller). The controller may include memory and a processor. The memory may store instructions executable by the processor to perform control strategies, such as actuator pressure, heat temperature, roller speeds/feeds, etc. Furthermore, the controller may further receive control inputs from a machine operator to adjust the machine as well as various machine sensors. In some examples, the machine operator inputs may include knobs, switches, foot pedals, combinations thereof, and the like. The memory may include known data storage mediums such as volatile and non-volatile memory, such as random access memory (RAM) and read only memory (ROM), respectively, and the like. Further, the processor may include one or more microprocessors. The controller may send control signals, commands, etc. to controllable components such as the heat device 102, the actuator 156, etc. and receive signals from sensors and/or components in the machine. The controller may also output sensor data and control settings to a central display, including pressures, temperatures, speeds/feeds, and the like for the machine operator to monitor during machine operation. It will therefore be understood that the controller may be in electronic communication (e.g., wired and/or wireless communication) with the sensors and controllable components. For instance, the controller may send commands to the heat device 102 to alter the temperature and/or flowrate of the heated air generated by the device. Responsive to receiving the control command, an actuator in the heat device may be adjusted to achieve the desired outcome. The other controllable components may function in a similar manner. A motor position sensor may be integrated into the motor controller loop. The machine may be configured to change feed speed (using a knob and/or secondary pedal, for example). To elaborate, the feed speed may be altered in a continuously variable manner or may be changed in pre-defined steps to allow the feeds to be consistent and smooth. In one example, the machine may be designed with functionality to electronically, pneumatically, and/or hydraulically engage and disengage the heater when the motors start and stop.

The control assembly 300 is coupled to the electronics mounting structure 154, in the illustrated example. To elaborate, in the illustrated example, the control assembly 300 is positioned below the motors 122, 124, the sidewall spool 126, and the heat device 102. Positioning the control assembly in this manner increases machine compactness and decreases the likelihood of the control assembly undesirably interfering with material welding. The control assembly 300 is further depicted on the side 138 of the machine that is opposite to the side 136 of the machine with the rollers positioned thereon. In this way, the material may be more easily manipulated during welding by driving down the likelihood of other machine components spatially interfering with the material welding process.

The base beams 146 may define a two-dimensional footprint of the machine. The upper machine components may be positioned within the footprint of the machine to enable the machine to be efficiently moved around the floor of the manufacturing facility and improve stability. However, other configurations are possible. Further, the spool 126 may be positioned outboard from the motors 122, 124 to allow the sidewall material to be effectively fed into the welding interface between the rollers. The sidewall material may be a drop stitch sidewall, tape such as thermoplastic polyurethane (TPU) tape, and the like. However, alternate spool positions are possible. A vertical cable beam 301 is also depicted in FIG. 3. The vertical cable beam 301 allows cables 302 to be routed therethrough to reduce the likelihood of the cables interfering with fabric welding operation or impeding movement of the machine around the floor of the manufacturing facility. In other embodiments, the control assembly 300 may be housed in an enclosure to protect the electronics.

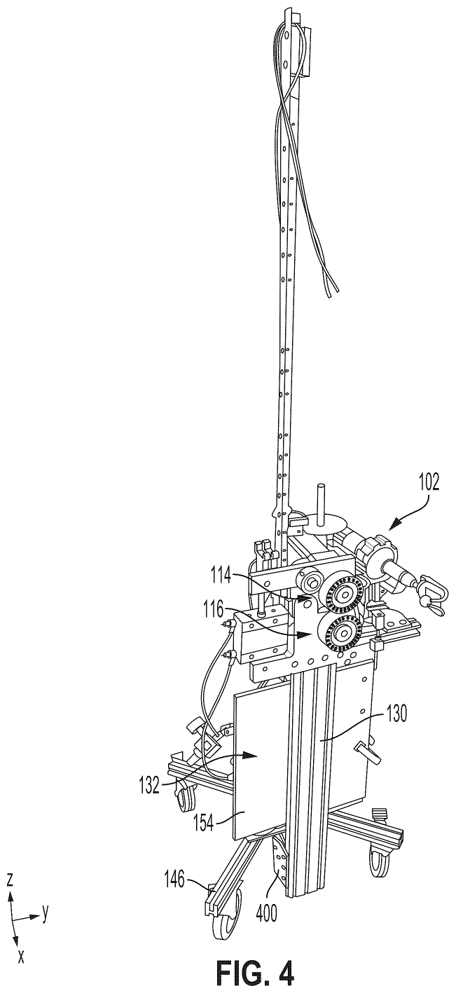

FIG. 4 shows another example of a dual edge binder machine 100. The rollers 114, 116, heat device 102, and the support frame 132 are again depicted. the electronics mounting structure 154 is shown positioned vertically below the rollers 114, 116, allowing the machine's compactness to be increased.

FIG. 4 shows the vertical beam 130 mounted to the base beams 146 via cross-member 400. The cross-member 400 may be positioned substantially level with the base beams 146 to decrease the machine's center of gravity, thereby enhancing the machine's portability. To elaborate, the cross-member 400 may be positioned in a space between the base beams 146. However, other beam attachment techniques may be used in other examples.

Additionally, FIGS. 1-4, 8, 15, and 17-18 include an axis system with an x-axis, y-axis, and z-axis, for spatial reference. In one example, the z-axis may be vertically aligned (e.g., parallel to gravitational axis, the y-axis may be longitudinally aligned, and the x-axis may be laterally aligned. However, other orientations of the axes are possible.

FIG. 5 shows an example of a drop stitch fabric assembly 500 which may be welded by the dual edge binder machine depicted in FIGS. 1-4. However, it will be understood that the machine may weld other suitable fabrics or materials such as plastics, for instance.

The drop stitch fabric assembly 500 in the illustrated example includes an upper section 502 and a lower section 504 which are connected via drop yarns 506. The upper section 502 includes a base fabric 508, an inner polymer coating 510, a reinforcement or chafer layer 512, and an outer polymer coating 514. In other examples, the coating 510 and/or the reinforcement or chafer layer 512 may be omitted from the fabric assembly. The lower section 504 may have a similar layered construction to the upper section 502. For instance, the lower section 504 includes a base fabric 516, etc. Sidewall material 518 is welded to the upper section 502 and the lower section 504. To elaborate, the sidewall fabric may include a compatible thermoplastic material coated on both sides of a reinforcement fabric layer that when heated and pressed onto the drop stitch creates a sealed structural bond.

FIG. 6 shows a cross-sectional view of a drop stitch fabric assembly 600 which includes a sidewall 602, an upper piece 604, and a lower piece 606. Further, drop yarns 608 are shown coupling the upper piece 604 and the lower piece 606. The dual edge binder machines are configured to simultaneously weld the sidewall to the upper piece and the lower piece thereby increasing product manufacturing efficiency.

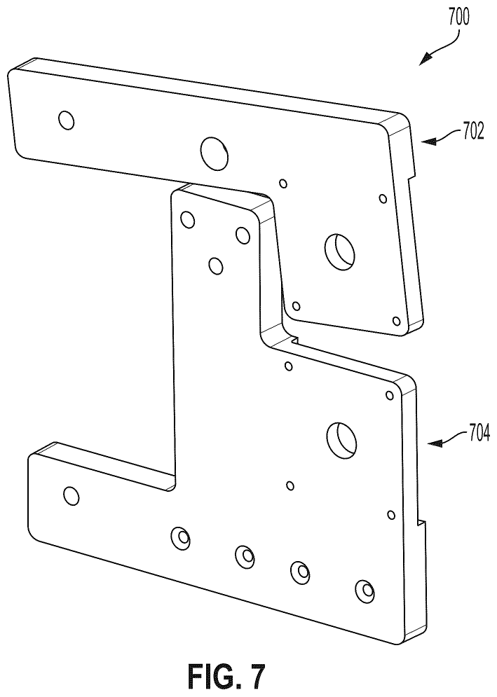

FIG. 7 shows a detailed view of an example of a plate assembly 700 which includes an upper plate 702 and a lower plate 704. It will be understood that the rollers may be coupled to the upper plate and the lower plate. An actuator (e.g., the actuator 156 shown in FIG. 1) may be coupled to the plates and configured to pivot the upper plate about a hinge to alter the relative positions of the rollers.

FIG. 8 shows a detailed view of a folder assembly 800 which includes the folder 143. The folder 143 allows the sidewall material to be effectively fed into the interface between the upper roller 114 and the lower roller 116. The folder 143 include angled extensions 802 which allow the sidewall material to be fed into the interface between the rollers in a desired manner.

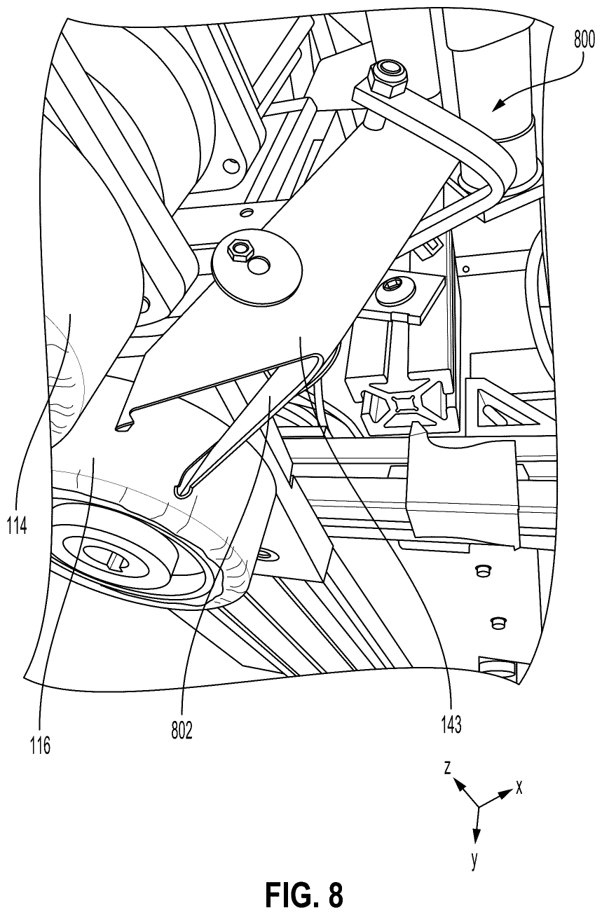

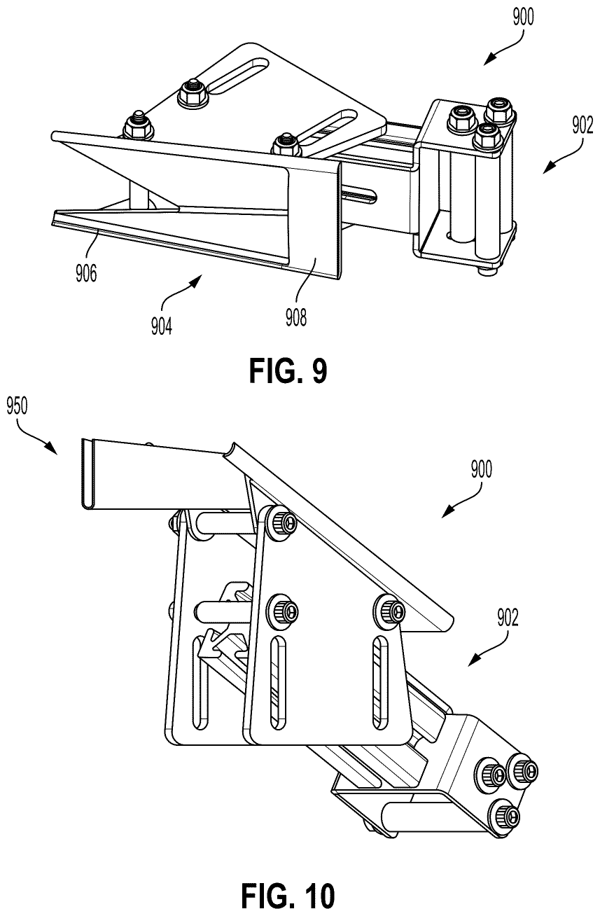

FIGS. 9-10 show another example of a folder assembly 900 which includes a mounting structure 902 and a folder 904. The folder 904 may include lips 906 at its lateral periphery to assist in effectively guiding the sidewall into the rollers without undesirably creasing, jamming, and the like. The folder 904 may further include a bridge 908 which further decreasing the likelihood of the sidewall undesirably creasing and jamming.

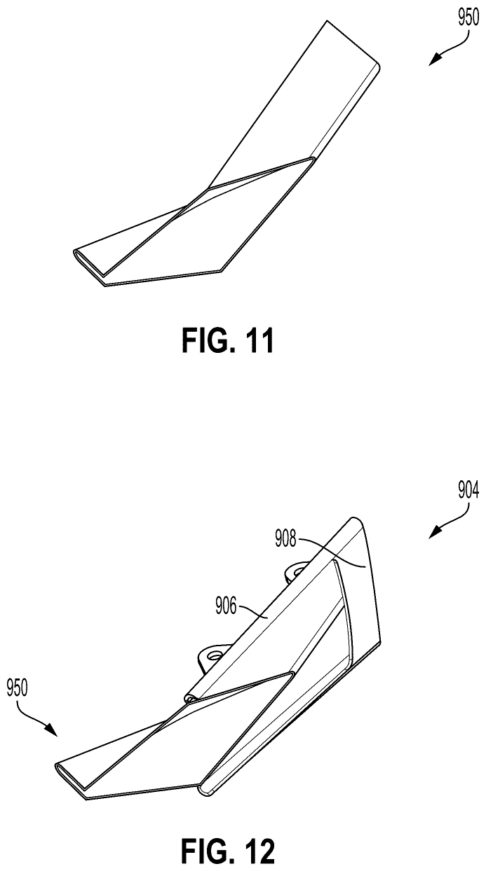

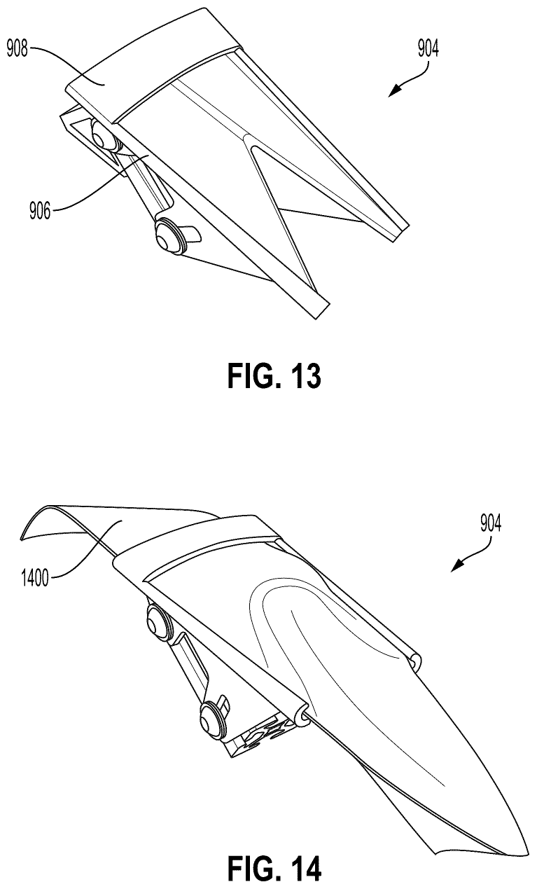

FIGS. 10, 11, and 12 show sidewall fabric 950 which has been folded by the folder in the dual edge binder machine. FIGS. 12-13 show different detailed view of the folder 904. The lips 906 and the bridge 908 of the folder are again depicted.

FIG. 14 shows sidewall fabric 1400 that is fed into the folder 904. As shown, the sidewall fabric 1400 exits the folder in an inverter manner which allows the sidewall to be smoothly and consistently welded to the top and bottom fabric sections in fabric assembly.

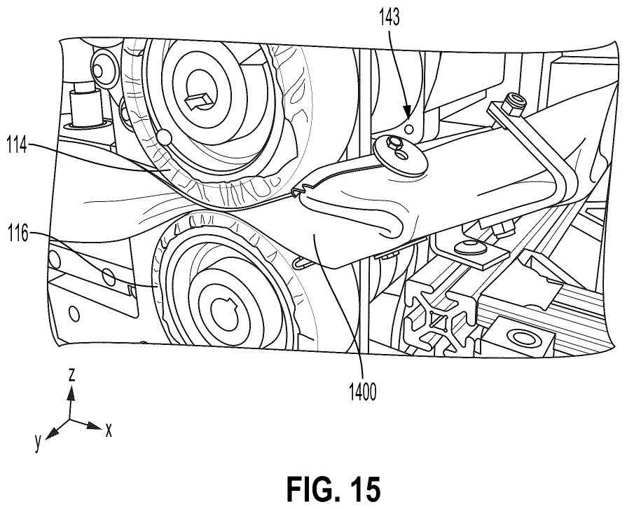

FIG. 15 shows the sidewall fabric 1400 fed into the folder 143 and then into the interface between the upper roller 114 and the lower roller 116. As shown, the sidewall fabric 1400 is orientated in a desired manner for effective fabric welding.

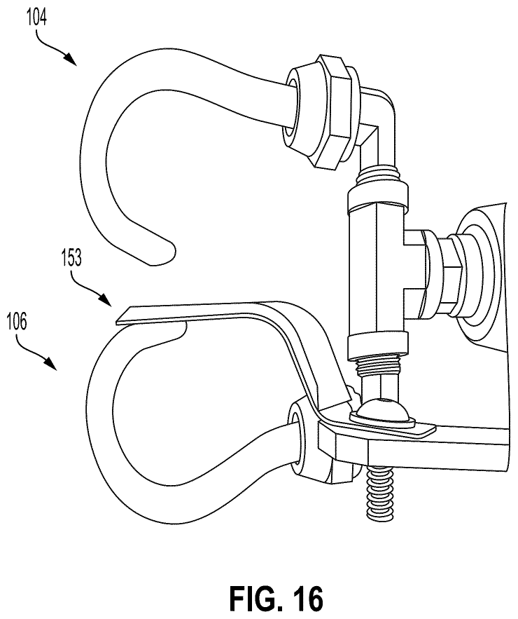

FIG. 16 shows a detailed view of the upper nozzle 104, the lower nozzle 106, and the heat shield 153. As previously discussed, an anti-friction coating such as PTFE, a ceramic material, and the like may be applied to the heat shield to protect the material beyond the welding field. Further, in one example, a shunt may be used in the machine to divert hot air and promote easier start/stop when introducing or removing the machine from the material.

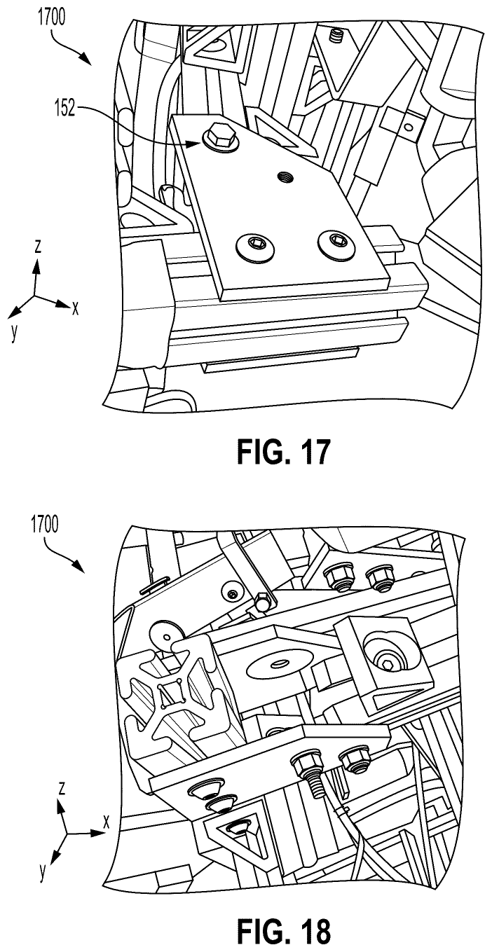

FIGS. 17-18 show a swivel 1700 which may be coupled to an arm which is coupled to the heat device in the dual edge binder machine. To elaborate, the swivel 1700 may include the pivot 152. The swivel 1700 allows the heat device and the nozzles which receive heated air therefrom to be moved into a desired position which allows the heat device to be engaged and disengaged for welding operation. To expound, the swivel 1700 allows the nozzles and the heat device to be swing out to remove the heat device and the nozzles from the workspace, before welding operation. In an alternate example, braided hoses may be used in the machine.

The dual edge binder machine described herein may have a non-destructive evaluation (NDE) system integrated therein. To elaborate, the NDE system is configured to evaluate the quality and detect defects in the welded material during or after the welding process. The NDE system may be configured as a visual NDE system that may include a visual inspection camera, a visual evaluation program that determines the quality of the material welds, and the like. Additionally or alternatively, the NDE system may be configured as an ultrasonic NDE system, an eddy current NDE system, a radiography NDE system, combinations thereof, and the like.

FIGS. 1-18 provide for a method for operation of a dual edge binder machine. The method includes, in one example, simultaneously heat welding an upper side and a lower side of a fabric assembly that includes an upper piece and a lower piece, which are coupled together via drop stitch yarns, and a sidewall. In this way, a drop stitch fabric assembly may be efficiently manufactured. In one example, simultaneously heat welding the upper and the lower side of the fabric assembly may include simultaneously delivering heated air from the heat device to an upper nozzle and a lower nozzle to heat both the outer polymer layer of the upper and lower drop stitch fabric materials and the inner polymer layer of the sidewall. Further, in one example, simultaneously heat welding the upper and the lower side of the fabric assembly may include driving the first motor and the second motor via motor drivers, wherein the first motor and the second motor are positioned coaxial to the upper roller and the lower roller respectively. The method may further include feeding and wrapping the sidewall around the edge as the interface is being heated. Further, in the method, the rollers feed the fabric assembly and apply pressure.

FIGS. 1-18 further provide for another method for operation of the dual edge binder machine. The method includes, in one example, turning on the dual edge binder machine. Next the method includes, actuating (e.g., air actuating) the jaws open. This jaw opening step may automatically occur. Next the method includes, setting a desired feed rate with push buttons, dials, digit controls, combinations thereof, and the like. Next the method includes determining that the sidewall tape is wound on the spool in a desired manner. Next the method includes pulling the sidewall tape through the folding mechanism between the open drive rollers. The method further includes engaging (e.g., closing) the drive roller via a foot pedal or a toggle switch to advance the tape. Next the method includes disengaging (e.g., opening) the drive rollers. Next the method includes, with the swivel mount rotated out, turning on the heat device (e.g., the heat gun) at a set-point. Next the method includes waiting for the heat device to reach the set-point and holding the heat device at the set-point. Next the method includes rotating the swivel mount in so that the air nozzle is positioned between the folding die and the open drive rollers. Next the method includes introducing the drop stitch between the air nozzle and the open roller so that the forward edge of the drop stitch is a desired distance beyond the roller center. Next the method includes engaging the rollers with a foot switch or a toggle switch. Next the method includes, automatically advancing panel welding at a fixed rate. Next the method includes cutting the tape at the rear of the folding die when the welded pane approaches a desired stopping location. It will be appreciated that this step may be omitted from the method if the tape is cut to a length of the perimeter before-hand. Next the method includes releasing the foot switch or the toggle switch to stop the drive rollers and opening the jaws automatically. Next the method includes removing the welded panel from the open rollers and the hot air nozzle. Next the method includes rotating the swivel mount out and away from the drive rollers. Next the method includes setting the hot air gun down to cool.

The technical effect of the method for operation of the dual edge binder machine is to efficiently and simultaneously heat weld the sidewall to both the top and bottom drop stitch fabrics to decrease manufacturing times associated with fabric construction, thereby improving quality, reducing cost, and increasing process efficiency.

FIGS. 1-18 are drawn to scale, though other relative dimensions may be used. Further, FIGS. 1-18 show the relative positioning of the various components of the watercraft assembly. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Elements offset or opposite from one another may be referred to as such, in one example. Unless otherwise indicated, the terms “approximately” and “substantially” may be construed to mean plus or minus five percent or less from a value or range.

In the following paragraphs, the subject matter of the present disclosure is further described. According to one aspect, a dual edge binder machine is provided that comprises a heat device configured to generate heat; an upper roller and a lower roller; one or more motors rotationally coupled to the upper roller and the lower roller respectively; wherein the heat device is positioned adjacent to an interface formed between the upper roller and the lower roller and delivers heat to an upper side and a lower side of a material assembly; and a sidewall spool configured to have a roll of sidewall material mounted thereto; wherein the heat device, the upper roller, and the lower roller are configured to weld an upper piece and a lower piece to a sidewall in the material assembly. In one example, the heat device may be configured to deliver heated air to an upper nozzle and a lower nozzle, wherein the upper nozzle and the lower nozzle are positioned adjacent to the interface. Further, in one example, the dual edge binder machine may further include a heat shield positioned between the upper nozzle and the lower nozzle. In yet another example, the heat shield may include an anti-friction coating. In another example, the heat device may be configured to generate radiant heat. In yet another example, the material assembly may be a drop stitch fabric assembly. Still further in another example, the dual edge binder machine may further include a folder assembly positioned adjacent to the upper roller and the lower roller. In another example, the folder assembly may include an antifriction coating such as polytetrafluoroethylene (PTFE). Still further in another example, the dual edge binder machine may further include an arm coupled to the heat device; and a swivel coupled to the arm and configured to pivot the arm. In another example, the dual edge binder machine may be configured to maneuver around a perimeter of the material assembly. In another example, the dual edge binder machine may further include an actuator coupled to the support frame configured such that the relative position between the rollers can be controlled. In another example, the dual edge binder machine may further include an upper drive plate pivotally coupled to a lower drive plate, wherein the actuator is coupled to the upper drive plate and the lower drive plate. In yet another example, the first and second motors may be stepper motors. In another example, the dual edge binder machine may further comprise non-destructive evaluation (NDE) system configured to evaluate the material assembly.

In another aspect, a method for operation of a dual edge binder machine is provided that comprises simultaneously heat welding a sidewall to an upper side and a lower side of a material assembly; wherein the dual edge binder machine comprises: a heat device; and an upper roller and a lower roller; one or more motors rotationally coupled to the upper roller and the lower roller respectively; wherein the heat device is configured to heat the material assembly which is adjacent to an interface formed between the upper roller and the lower roller; and a sidewall spool with a roll of sidewall material. In one example, simultaneously heat welding the upper side and the lower side of the material assembly may include simultaneously delivering heated air from the heat device to an upper nozzle and a lower nozzle. In another example, the dual edge binder machine may be configured to be moved around the material assembly which is positioned on a stationary table. In another example, the method may further comprise driving the one or more motors to feed the material assembly to the interface. In another example, the material assembly may be a drop stitch fabric assembly that includes an upper piece which is stitched to a lower piece and a sidewall.

In another aspect, a dual edge binder machine is provided that comprises a heat device configured to generate heat; an upper roller and a lower roller; one or more motors rotationally coupled to the upper roller and the lower roller respectively; wherein the heat device is positioned adjacent to an interface formed between the upper roller and the lower roller and is configured to deliver heat to an upper side and a lower side of a fabric assembly; a sidewall spool configured to have a roll of sidewall material mounted thereto; and an upper drive plate pivotally coupled to a lower drive plate; and an actuator coupled to the upper drive plate and the lower drive plate and configured to adjust the relative position between the upper roller and the lower roller. In one example, the dual edge binder machine may further comprise an upper nozzle and a lower nozzle that receive heated air from the heat device; and a folder assembly positioned adjacent to the upper roller and the lower roller.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A dual edge binder machine comprising:
a heat device configured to generate heat;
an upper roller and a lower roller;
one or more motors rotationally coupled to the upper roller and the lower roller respectively;
wherein the heat device is positioned adjacent to an interface formed between the upper roller and the lower roller and delivers heat to an upper side and a lower side of a material assembly; and
a sidewall spool configured to have a roll of sidewall material mounted thereto;
wherein the heat device, the upper roller, and the lower roller are configured to weld an upper piece and a lower piece to a sidewall in the material assembly.

2. The dual edge binder machine of claim 1, wherein the heat device is configured to deliver heated air to an upper nozzle and a lower nozzle, wherein the upper nozzle and the lower nozzle are positioned adjacent to the interface.

3. The dual edge binder machine of claim 2, further comprising a heat shield positioned between the upper nozzle and the lower nozzle.

4. The dual edge binder machine of claim 3, wherein the heat shield includes an anti-friction coating.

5. The dual edge binder machine of claim 1, wherein the heat device is configured to generate radiant heat.

6. The dual edge binder machine of claim 1, wherein the material assembly is a drop stitch fabric assembly.

7. The dual edge binder machine of claim 1, further comprising a folder assembly positioned adjacent to the upper roller and the lower roller.

8. The dual edge binder machine of claim 1, further comprising a non-destructive evaluation (NDE) system configured to evaluate the material assembly.

9. The dual edge binder machine of claim 1, further comprising:
an arm coupled to the heat device; and
a swivel coupled to the arm and configured to pivot the arm.

10. The dual edge binder machine of claim 1, wherein the dual edge binder machine is configured to maneuver around a perimeter of the material assembly.

11. The dual edge binder machine of claim 1, further comprising an actuator configured to control the relative position between the upper roller and the lower roller.

12. The dual edge binder machine of claim 11, further comprising an upper drive plate pivotally coupled to a lower drive plate, wherein the actuator is coupled to the upper drive plate and the lower drive plate.

13. The dual edge binder machine of claim 1, wherein the first and second motors are stepper motors.

14. A method for operation of a dual edge binder machine, comprising:
simultaneously heat welding a sidewall to an upper side and a lower side of a material assembly;
wherein the dual edge binder machine comprises:
a heat device; and
an upper roller and a lower roller;
one or more motors rotationally coupled to the upper roller and the lower roller respectively;
wherein the heat device is configured to heat the material assembly which is adjacent to an interface formed between the upper roller and the lower roller; and
a sidewall spool with a roll of sidewall material.

15. The method of claim 14, wherein simultaneously heat welding the upper side and the lower side of the material assembly includes simultaneously delivering heated air from the heat device to an upper nozzle and a lower nozzle.

16. The method of claim 14, wherein the dual edge binder machine is configured to be moved around the material assembly which is positioned on a stationary table.

17. The method of claim 14, further comprising driving the one or more motors to feed the material assembly to the interface.

18. The method of claim 14, wherein the material assembly is a drop stitch fabric assembly that includes an upper piece which is stitched to a lower piece and a sidewall.

19. A dual edge binder machine comprising:
a heat device configured to generate heat;
an upper roller and a lower roller;
one or more motors rotationally coupled to the upper roller and the lower roller respectively;
wherein the heat device is positioned adjacent to an interface formed between the upper roller and the lower roller and is configured to deliver heat to an upper side and a lower side of a fabric assembly;
a sidewall spool configured to have a roll of sidewall material mounted thereto; and
an upper drive plate pivotally coupled to a lower drive plate; and
an actuator coupled to the upper drive plate and the lower drive plate and configured to adjust the relative position between the upper roller and the lower roller.

20. The dual edge binder machine of claim 19, further comprising:
an upper nozzle and a lower nozzle that receive heated air from the heat device; and
a folder assembly positioned adjacent to the upper roller and the lower roller.
